(19) United States
(12) Patent Application Publication
(10) Pub. No.: US 2024/0085443 A1
(43) Pub. Date: Mar. 14, 2024

(54) LIQUID HANDLING DEVICE, LIQUID HANDLING SYSTEM, AND LIQUID HANDLING METHOD

(71) Applicant: Enplas Corporation, Saitama (JP)

(72) Inventor: Nobuya SUNAGA, Saitama (JP)

(73) Assignee: Enplas Corporation, Saitama (JP)

(21) Appl. No.: 18/273,043

(22) PCT Filed: Jan. 20, 2021
(86) PCT No.: PCT/JP2021/001864

§ 371 Date: Jul. 19, 2023

(51) Int. Cl. G01N 35/08; G01N 35/10

(52) U.S. Cl. CPC G01N 35/08; G01N 35/1065

(57) ABSTRACT

This liquid handling device comprises a first flow path, a second flow path, a third flow path, an introduction opening, a discharge opening, an introduction valve, and a discharge valve. The third flow path comprises a first area under detection that is disposed in the third flow path and includes a roughened surface so as to have light emitted thereon for the purpose of transmitted light or reflected light detection and a second area under detection that is disposed further to one side of the third flow path than the first area under detection and includes a roughened surface so as to have light emitted thereon for the purpose of transmitted light or reflected light detection.

### TECHNICAL FIELD

The present invention relates to a liquid handling device, a liquid handling system, and a liquid handling method each for proper weighing of a liquid.

### BACKGROUND ART

In recent years, channel chips are used to analyze trace amounts of substances such as proteins and nucleic acids with high precision and speed. Channel chips have advantages of requiring only small amounts of reagents and samples for analysis, and are expected to be used in various applications such as clinical, food, and environmental testing.

In addition, chips for performing various tests is required to accurately weigh the amount of liquid such as a sample. For example, in Patent Literature (hereinafter, referred to as PTL) 1, a large amount of liquid is provided into a quantifying part to allow the liquid to overflow from the quantifying part, thereby weighing the liquid corresponding to the volume of the quantifying part. The quantified liquid is tested by being applied to a test piece.

### CITATION LIST

### Patent Literature

### PTL 1

Japanese Patent Application Laid-Open No. 2015-194354

### SUMMARY OF INVENTION

### Technical Problem

In the technique disclosed in PTL 1, air bubbles may be mixed in the liquid stored in the quantifying part. When air bubbles are mixed in the liquid, the test may fail to perform properly.

An object of the present invention is to provide a liquid handling device, a liquid handling system, and a liquid handling method that allow for more accurate weighing of a liquid with no mixing of air bubbles into the liquid.

### Solution to Problem

A liquid handling device of the present invention includes the following: a first channel; a second channel; a third channel with one end thereof connected to one end of the first channel and to one end of the second channel; an introduction port connected to the first channel or the second channel; a discharge port connected to the first channel or the second channel; an introduction valve disposed in a first connection part between the introduction port and the first channel or the second channel, the first channel or the second channel being a channel to which the introduction port is connected; and a discharge valve disposed in a second connection part between the discharge port and the first channel or the second channel, the first channel or the second channel being a channel to which the discharge port is connected, in which
the third channel includes a first to-be-detected region including the following: a roughened surface including a roughened surface and being configured to be irradiated with light for detection of transmitted light or reflected light, the first to-be-detected region being disposed in the third channel; and a second to-be-detected region including a roughened surface and being configured to be irradiated with light for detection of transmitted light or reflected light, the second to-be-detected region being disposed in the third channel and closer to the one end of the third channel than the first to-be-detected region is.

A liquid handling system of the present invention includes the following: the liquid handling device of the present invention; a first light detection part disposed to face the first to-be-detected region; and a second light detection part disposed to face the second to-be-detected region.

A liquid handling method of the present invention is a liquid handling method for weighing a liquid by using the liquid handling system of the present invention, and includes performing a procedure more than once, and in the procedure, a liquid is introduced from the introduction port into the third channel until a surface of the liquid is positioned at the first light detection part, and then the liquid inside the third channel and with the surface thereof at the first light detection part is moved toward the one end of the third channel so that the surface of the liquid is positioned at the second light detection part.

### Advantageous Effects of Invention

The present invention can provide a liquid handling device, a liquid handling system, and a liquid handling method each capable of weighing a liquid with no mixing of air bubbles into the liquid.

### BRIEF DESCRIPTION OF DRAWINGS

FIG. 1A is a cross-sectional view illustrating a liquid handling system according to an embodiment, and FIG. 1B is a bottom view of the liquid handling device according to the embodiment;

FIG. 2A is a plan view of the liquid handling device according to the embodiment, FIG. 2B is a bottom view of the liquid handling device, and FIG. 2C is a bottom view of a substrate;

FIG. 3 is a bottom view for explaining the liquid handling device according to the embodiment;

FIGS. 4A and 4B are diagrams for explaining a first to-be-detected region and a second to-be-detected region;

FIGS. 5A to 5C are diagrams for explaining a light shielding part;

FIG. 6A is a plan view of a first rotary member, and FIG. 6B is a cross-sectional view taken along line B-B of FIG. 6A;

FIG. 7A is a plan view of a second rotary member, and FIG. 7B is a cross-sectional view taken along line B-B of FIG. 7A;

FIGS. 8A and 8B are diagrams for explaining a pressure loss part;

FIGS. 9A to 9C are schematic diagrams for explaining the operation of the liquid handling system according to the embodiment; and

FIGS. 10A and 10B are schematic diagrams for explaining the operation of the liquid handling system according to the embodiment.

### DESCRIPTION OF EMBODIMENTS

Hereinafter, an embodiment of the present invention will be described in detail with reference to the drawings.

The present embodiment describes a liquid handling device and liquid handling system each for weighing a liquid in a channel.

Configurations of Liquid Handling System and Liquid Handling Device

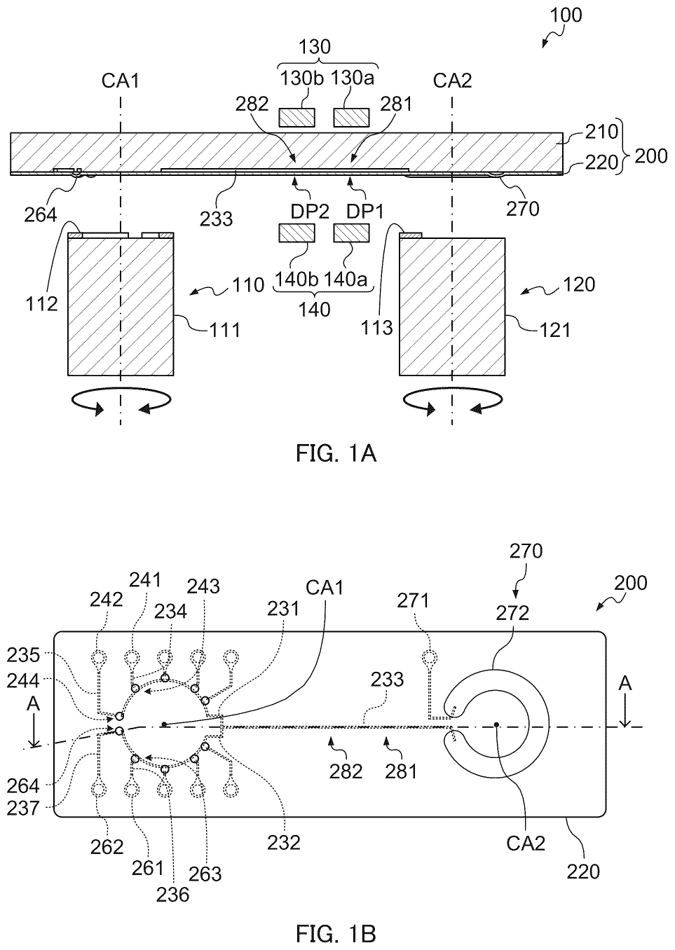

FIG. 1A is a cross-sectional view illustrating liquid handling system 100 according to the present embodiment. FIG. 1B is a bottom view of liquid handling device 200 according to the present embodiment. In FIG. 1B, internal components, such as channels, are indicated by dashed lines. The cross-section of liquid handling device 200 in FIG. 1A is a cross-sectional view taken along line A-A in FIG. 1B.

As illustrated in FIGS. 1A and 1B, liquid handling system 100 includes first rotary member 110, second rotary member 120, light irradiation part 130, light detection part 140, and liquid handling device 200. First rotary member 110 is rotated about first central axis CA1 by an external drive mechanism (not illustrated). Second rotary member 120 is rotated about second central axis CA2 by an external drive mechanism (not illustrated). Liquid handling device 200 includes substrate 210 and film 220, and film 220 is placed so as to contact with first rotary member 110 and second rotary member 120. Light irradiation part 130 and light detection part 140 are disposed with liquid handling device 200 therebetween. Light irradiation part 130 and light detection part 140 respectively detect whether a liquid reaches first to-be-detected region 281 and second to-be-detected region 282 in third channel 233 provided in liquid handling device 200. FIG. 1A illustrates the components separately for easy understanding of the configuration of liquid handling system 100.

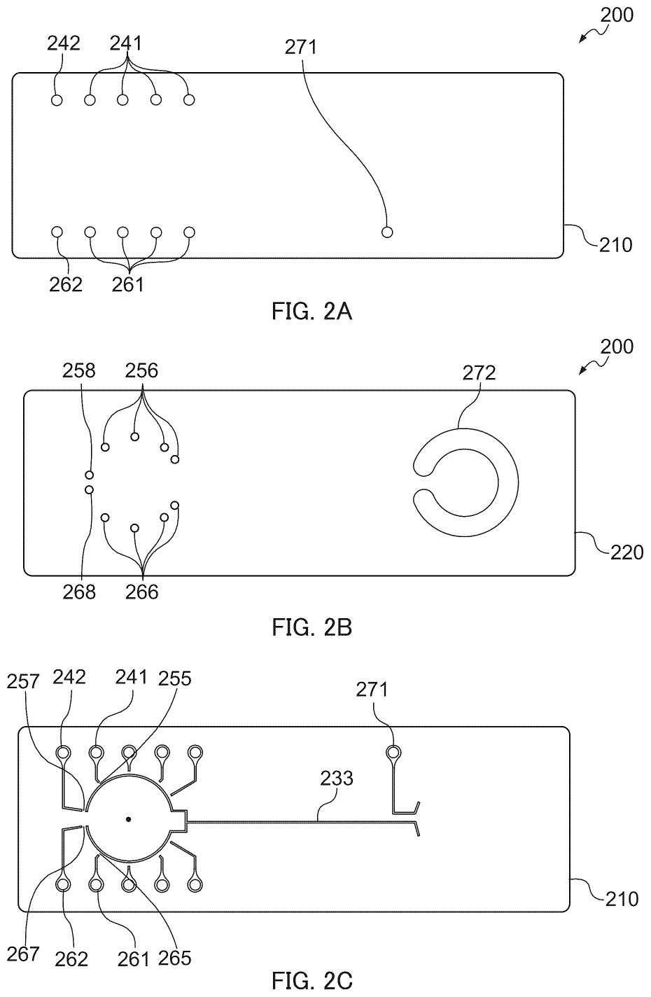

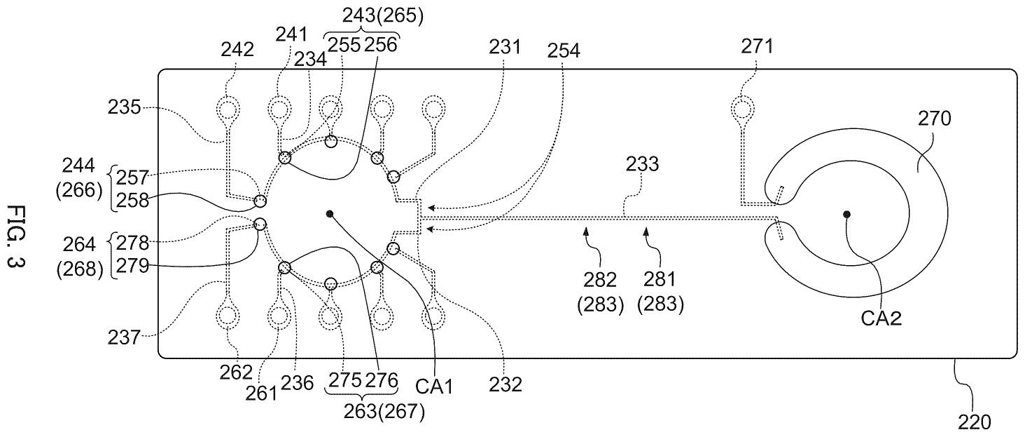

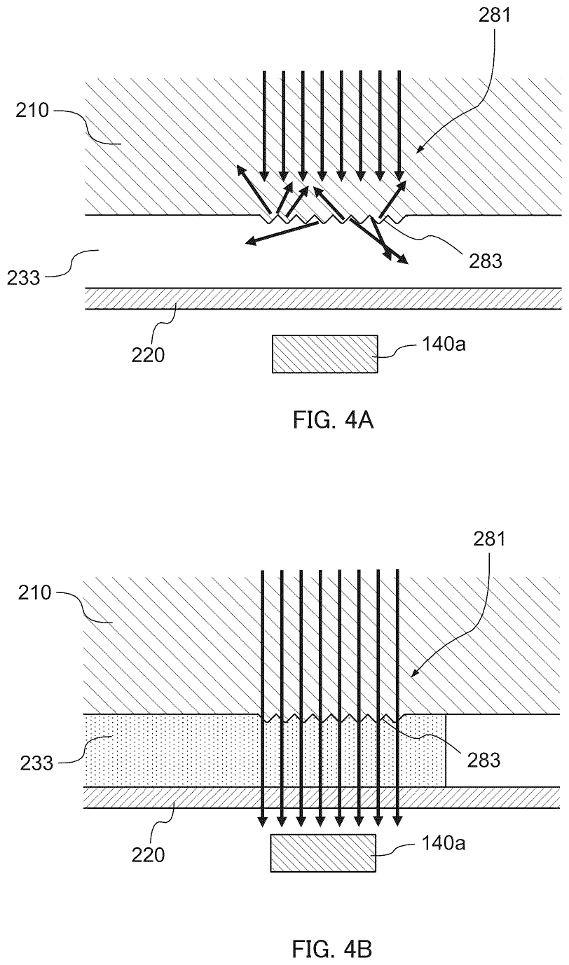

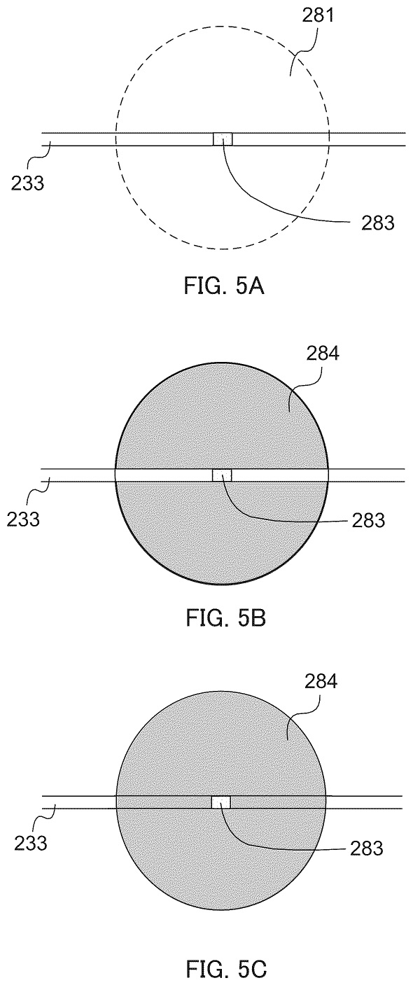

FIGS. 2A to 2C, 3, 4A, 4B and 5A to 5C each illustrate the configuration of liquid handling device 200. FIG. 2A is a plan view of liquid handling device 200 (plan view of substrate 210). FIG. 2B is a bottom view of liquid handling device 200 (bottom view of film 220). FIG. 2C is a bottom view of substrate 210 (bottom view of liquid handling device 200 with film 220 removed). FIG. 3 is a bottom view of liquid handling device 200 for explaining the configuration thereof (the same as FIG. 1B). In FIG. 3, components such as grooves (channels) formed in substrate 210 on the surface on the film 220 side are indicated by dashed lines. FIG. 4A is a cross-sectional schematic diagram illustrating a state in which diffused reflection occurs when no liquid is in first to-be-detected region 281 or second to-be-detected region 282. FIG. 4B is a schematic cross-sectional view illustrating a state in which diffused reflection is reduced when a liquid is in first to-be-detected region 281 or second to-be-detected region 282. FIG. 5A is a partially enlarged plan view of liquid handling device 200 not including light shielding part 284; FIG. 5B is a partially enlarged plan view of liquid handling device 200 including light shielding part 284 in portions other than third channel 233; and FIG. 5C is a partially enlarged plan view of liquid handling device 200 including light shielding part 284 also in third channel 233.

As described above, liquid handling device 200 includes substrate 210 and film 220 (see FIG. 1A). In substrate 210, grooves to serve as channels and through holes to serve as introduction ports or discharge ports are formed. Film 220 is joined to one of the surfaces of substrate 210 so as to block the openings of the recesses and through holes formed in substrate 210. Some regions of film 220 function as diaphragms. The grooves of the substrate 210 blocked by film 220 serve as channels for fluids, such as reagents, liquid samples, washing liquids, gases, and powders.

The thickness of substrate 210 is not limited. For example, the thickness of substrate 210 is 1 mm or more and 10 mm or less. In addition, the material of substrate 210 is not limited. For example, the material of substrate 210 may be appropriately selected from known resins and glass. Examples of the materials of substrate 210 include polyethylene terephthalate, polycarbonate, polymethyl methacrylate, polyvinyl chloride, polypropylene, polyether, polyethylene, polystyrene, cyclo-olefine resins, silicone resins, and elastomers.

The thickness of film 220 is not limited as long as the film can function as a diaphragm. For example, the thickness of film 220 is 30 m or more and 300 m or less. In addition, the material of film 220 is not limited as long as the film can function as a diaphragm. For example, the material of film 220 may be appropriately selected from known resins. Examples of the materials of film 220 include polyethylene terephthalate, polycarbonate, polymethyl methacrylate, polyvinyl chloride, polypropylene, polyether, polyethylene, polystyrene, cyclo-olefine resins, silicone resins, and elastomers. Film 220 is joined to substrate 210 by, for example, heat welding, laser welding, or an adhesive.

As illustrated in FIG. 3, liquid handling device 200 according to the present embodiment includes first channel 231, second channel 232, third channel 233, first introduction ports 241, first discharge port 242, first introduction valves 243, first discharge valve 244, second introduction ports 261, second discharge port 262, second introduction valves 263, second discharge valve 264, rotary membrane pump 270, and vent hole 271. In the present embodiment, a plurality of first introduction ports 241 and a plurality of second introduction ports 261 are disposed. In addition, a plurality of first introduction valves 243 and a plurality of second introduction valves 263 are disposed.

Five bottomed recesses that can function as introduction ports or discharge ports are connected to first channel 231, and a valve is provided between each recess and first channel 231. Each recess functions as first introduction port 241 or first discharge port 242. In addition, each valve functions as first introduction valve 243 or first discharge valve 244. In the present embodiment, the introduction port and discharge port connected to first channel 231 are referred to as first introduction port 241 and first discharge port 242, respectively. In addition, a valve between first channel 231 and an introduction port connected to first channel 231 is referred to as first introduction valve 243, and a valve between first channel 231 and a discharge port connected to first channel 231 is referred to as first discharge valve 244. In the present embodiment, from the left in FIG. 3, the second to fifth recesses function as first introduction ports 241, and the second to fifth valves function as first introduction valves 243. The first recess and valve from the left in FIG. 3 function as first discharge port 242 and first discharge valve 244, respectively.

Similarly, five bottomed recesses that can function as introduction ports or discharge ports are connected to second channel 232, and a valve is provided between each recess and second channel 232. Each recess functions as second introduction port 261 or second discharge port 262. In addition, each valve functions as second introduction valve 263 or second discharge valve 264. In the present embodiment, the introduction port and discharge port connected to second channel 232 are referred to as second introduction port 261 and second discharge port 262, respectively. In addition, a valve between second channel 232 and an introduction port connected to second channel 232 is referred to as second introduction valve 263, and a valve between second channel 232 and a discharge port connected to second channel 232 is referred to as second discharge valve 264. In the present embodiment, from the left in FIG. 3, the second to fifth recesses function as second introduction ports 261, and the second to fifth valves function as second introduction valves 263. The first recess and valve from the left in FIG. 3 function as second discharge port 262 and second discharge valve 264, respectively.

First introduction port 241 and second introduction port 261 are bottomed recesses for introducing liquids into liquid handling device 200. First discharge port 242 and second discharge port 262 are bottomed recesses for taking out liquids from the inside of liquid handling device 200.

In the present embodiment, each of these recesses is formed of a through hole formed in substrate 210 and film 220 blocking one of the openings of the through hole. The shape and size of these recesses are not limited, and can be appropriately set according to the application. These recesses have, for example, a substantially cylindrical shape. The width of these recesses is, for example, approximately 2 mm. The type of liquid to be housed in first introduction port 241 or second introduction port 261 may be appropriately selected according to the application of liquid handling device 200. The liquid is a reagent, a liquid sample, a diluent, or the like.

First introduction port 241 is connected to first channel 231 via first introduction channel 234. First discharge port 242 is connected to first channel 231 via first discharge channel 235. Second introduction port 261 is connected to second channel 232 via second introduction channel 236. Second discharge port 262 is connected to second channel 232 via second discharge channel 237.

One end of third channel 233 is connected to one end of first channel 231 and to one end of second channel 232. Third channel 233 includes first to-be-detected region 281 and second to-be-detected region 282. First to-be-detected region 281 is disposed in third channel 233 closer to the other end of third channel 233 (closer to rotary membrane pump 270) than second to-be-detected region 282 is. First to-be-detected region 281 is irradiated with light for detection of transmitted light or reflected light. In addition, second to-be-detected region 282 is disposed in third channel 233 closer to the one end of the third channel (closer to the connection part with first channel 231 and second channel 232) than first to-be-detected region 281 is. Second to-be-detected region 282 is irradiated with light for detection of transmitted light or reflected light. First to-be-detected region 281 and second to-be-detected region 282 are each located between light irradiation part 130 and light detection part 140. Accordingly, in the present embodiment, light irradiation part 130 includes first light irradiation part 130a and second light irradiation part 130b, and light detection part 140 includes first light detection part 140a and second light detection part 140b. First light irradiation part 130a and first light detection part 140a are disposed to face each other with first to-be-detected region 281 therebetween. Second light irradiation part 130b and second light detection part 140b are disposed to face each other with second to-be-detected region 282 therebetween.

First to-be-detected region 281 and second to-be-detected region 282 each include roughened surface 283. Roughened surface 283 of first to-be-detected region 281 may be the same as or different from roughened surface 283 of second to-be-detected region 282. In the present embodiment, roughened surface 283 of first to-be-detected region 281 and roughened surface 283 of second to-be-detected region 282 have the same configuration. Roughened surface 283 is configured to diffusely reflect light. Roughened surface 283 may have any configuration as long as the surface causes diffused reflection when the surface is not in contact with liquid and reduces diffused reflection when the surface is in contact with liquid. For example, the surface roughness Ra (arithmetic average roughness) of roughened surface 283 is preferably 0.001 mm or more, more preferably 0.05 mm or more, and particularly preferably 0.1 mm or more, from the viewpoint of causing diffused reflection. The upper limit of the surface roughness Ra of roughened surface 283 is not limited as long as the surface roughness Ra is 1 mm or less. The surface roughness Ra of roughened surface 283 can be adjusted, for example, by adjusting the surface roughness of a mold to be used for forming grooves, which constitute channel 230, in substrate 210. The size of roughened surface 283 (the length in the flow direction of third channel 233 and the length in the width direction or depth direction of third channel 233) is not limited as long as light detection part 140 can detect liquid in third channel 233 in cooperation with light irradiation part 130. In the present embodiment, the length of roughened surface 283 in the width direction of third channel 233 is the same as the width of third channel 233.

Light irradiation part 130 (first light irradiation part 130a and second light irradiation part 130b) irradiates first to-be-detected region 281 and the second detection region (roughened surfaces 283) of third channel 233 with light. Light detection part 140 (first light detection part 140a and second light detection part 140b) detects light emitted from light irradiation part 130 and transmitted through roughened surface 283 or reflected by roughened surface 283, thereby detecting whether a liquid reaches first to-be-detected region 281 and second to-be-detected region 282. The wavelength of light emitted by light irradiation part 130 is not limited as long as the light can be detected by light detection part 140, and is appropriately set according to the type of liquid introduced into third channel 233, the materials of substrate 210 and film 220, and the like. For example, light irradiation part 130 is an infrared light emitting diode and light detection part 140 is a phototransistor. The positions of light irradiation part 130 and light detection part 140 are not limited as long as the parts can detect whether liquid reaches first to-be-detected region 281 and second to-be-detected region 282. In the present embodiment, light irradiation part 130 and light detection part 140 are disposed at positions facing each other with third channel 233 therebetween.

The present embodiment describes third channel 233 including first to-be-detected region 281 and second to-be-detected region 282; however, third channel 233 may include three or more to-be-detected regions. In this case, 3 or 4 light irradiation parts 130 and 3 or 4 light detection parts 140 are possible.

In the following, a method of detecting liquid in first to-be-detected region 281 and second to-be-detected region 282 will be described. The method of detecting liquid in first to-be-detected region 281 is the same as the method of detecting liquid in second to-be-detected region 282; thus, only the method of detecting liquid in first to-be-detected region 281 will be described.

As illustrated in FIG. 4A, when no liquid is in first to-be-detected region 281 of third channel 233, light is diffusely reflected on roughened surface 283 upon the irradiation of first to-be-detected region 281 with light from first light irradiation part 130a. As illustrated in FIG. 4B, on the other hand, when a liquid is in first to-be-detected region 281 of third channel 233, diffused reflection by roughened surface 283 is reduced; therefore, increased amount of light reaches first light detection part 140a upon the irradiation of first to-be-detected region 281 with light. As described above, the presence or absence of liquid in first to-be-detected region 281 causes significant changes in the amount of reflected light and transmitted light in first to-be-detected region 281 when roughened surface 283 is formed in first to-be-detected region 281. This allows the detection of the presence of liquid in first to-be-detected region 281 of third channel 233.

In addition, roughened surface 283 is preferably formed on a surface-through which the light from light irradiation part 130a is transmitted-among the surfaces forming first to-be-detected region 281 of third channel 233. Roughened surface 283 is more preferably formed in a surface perpendicular to the light from first light irradiation part 130a. This allows easier detection of the presence of liquid in first to-be-detected region 281. As illustrated in FIGS. 4A and 4B, the present embodiment describes an example in which roughened surface 283 is the surface formed from substrate 210 among the surfaces forming first to-be-detected region 281 of third channel 233; however, a surface formed from film 220 may serve as a roughened surface.

When the width of third channel 233 is small, first to-be-detected region 281 including roughened surface 283 is also small. As indicated by the dashed line in FIG. 5A, however, the light irradiation region irradiated with light by first light irradiation part 130a (for example, light emitting diode (LED)) and the light detection region where light is detected by first light detection part 140a (for example, phototransistor) may be significantly larger than first to-be-detected region 281 including roughened surface 283. When the light irradiation region, which is irradiated with light by first light irradiation part 130a, and the light detection region, where light is detected by first light detection part 140a, are significantly larger than first to-be-detected region 281 (roughened surface 283) in this manner, first light detection part 140a may fail to properly detect changes in diffusion in first to-be-detected region 281 (roughened surface 283). In this regard, liquid handling device 200 may further include light shielding part 284 provided around first to-be-detected region 281. For example, as illustrated in FIG. 5B, light shielding part 284 may be disposed so as not to overlap third channel 233 when liquid handling device 200 is viewed in plan view. This configuration allows first light detection part 140a to detect changes in diffusion in first to-be-detected region 281 (roughened surface 283) with higher sensitivity.

In addition, as illustrated in FIG. 5C, light shielding part 284 may be disposed, in addition to the regions that do not overlap third channel 233, at a position so as to overlap a region other than first to-be-detected region 281 (roughened surface 283) of third channel 233 when liquid handling device 200 is viewed plan view. This configuration allows first light detection part 140a to detect changes in diffusion in first to-be-detected region 281 (roughened surface 283) with still higher sensitivity.

First channel 231, second channel 232, third channel 233, first introduction channel 234, first discharge channel 235, second introduction channel 236, and second discharge channel 237 are channels through which fluid can move. One end of first channel 231 and one end of second channel 232 are connected to one end of third channel 233. The upstream ends of first introduction channel 234 and second introduction channel 236 are respectively connected to first introduction port 241 and second introduction port 261. The downstream end of first introduction channel 234 is connected to first channel 231 via first introduction connection part 265, and the downstream end of second introduction channel 236 is connected to second channel 232 via second introduction connection part 267. The upstream end of first discharge channel 235 is connected to first channel 231 via first discharge connection part 266, and the upstream end of second discharge channel 237 is connected to second channel 232 via second discharge connection part 268. The downstream ends of first discharge channel 235 and second discharge channel 237 are respectively connected to first discharge port 242 and second discharge port 262.

First introduction channels 234, first discharge channel 235, and third channel 233 are connected to first channel 231. First introduction channels 234 and first discharge channel 235 are connected to first channel 231 in this order from the end (to which third channel 233 is connected) of first channel 231. Second introduction channels 236, second discharge channel 237, and third channel 233 are connected to second channel 232. Second introduction channels 236 and second discharge channel 237 are connected to second channel 232 in this order from the end (to which third channel 233 is connected) of second channel 232. One end of first channel 231 and one end of second channel 232 are connected to one end of third channel 233. The other end of third channel 233 is connected to rotary membrane pump 270.

In the present embodiment, each of these channels is formed of a groove formed in substrate 210 and film 220 blocking the opening of the groove. The cross-sectional area and cross-sectional shape of these channels are not limited. Herein, a “cross section of a channel” means a cross section of a channel, and the cross section is perpendicular to the direction in which a liquid flows. The cross-sectional shape of these channels is, for example, a substantially rectangular shape with a side length (width and depth) of about several tens of m. The cross-sectional area of each channel may or may not be constant in the direction of fluid flow. In the present embodiment, the cross-sectional area of the channel in the regions other than pressure loss part 254 is constant.

First introduction valve 243, first discharge valve 244, second introduction valve 263, and second discharge valve 264 are membrane valves (diaphragm valves) that control the flow of liquid inside first introduction channel 234, first discharge channel 235, second introduction channel 236, and second discharge channel 237, respectively. In the present embodiment, these valves are rotary membrane valves whose opening and closing are controlled by the rotation of first rotary member 110. In the present embodiment, these valves are disposed on the same circumference (one circumference) with first central axis CA1 at the center.

First introduction valve 243 is disposed in first introduction connection part 265 that is between first introduction channel 234 and first channel 231. Second introduction valve 263 is disposed in second introduction connection part 267 that is between second introduction channel 236 and second channel 232. First discharge valve 244 is disposed in first discharge connection part 266 that is between first discharge channel 235 and first channel 231. Second discharge valve 264 is disposed in second discharge connection part 268 that is between second discharge channel 237 and second channel 232.

First introduction valve 243 includes partition wall 255 and diaphragm 256. First discharge valve 244 includes partition wall 257 and diaphragm 258. Second introduction valve 263 includes partition wall 275 and diaphragm 276. Second discharge valve 264 includes partition wall 278 and diaphragm 279.

In the present embodiment, partition wall 255 of first introduction valve 243 is disposed between first introduction channel 234 and first channel 231 (at first introduction connection part 265). Diaphragm 256 of first introduction valve 243 is disposed so as to face partition wall 255. Partition wall 257 of first discharge valve 244 is disposed between first discharge channel 235 and first channel 231 (at first discharge connection part 266). Diaphragm 258 of first discharge valve 244 is disposed so as to face partition wall 257. Partition wall 275 of second introduction valve 263 is disposed between second introduction channel 236 and second channel 232 (at second introduction connection part 267). Diaphragm 276 of second introduction valve 263 is disposed so as to face partition wall 275. Partition wall 278 of second discharge valve 264 is disposed between second discharge channel 237 and second channel 232 (at second discharge channel 237). Diaphragm 279 of second discharge valve 264 is disposed so as to face partition wall 278.

Partition wall 255 of first introduction valve 243 functions as a valve seat of a membrane valve (diaphragm valve) for opening and closing the area between first introduction channel 234 and first channel 231. Partition wall 257 of first discharge valve 244 functions as a valve seat of a membrane valve for opening and closing the area between first channel 231 and first discharge channel 235. Partition wall 275 of second introduction valve 263 functions as a valve seat of a membrane valve for opening and closing the area between second introduction channel 236 and second channel 232. Partition wall 278 of second discharge valve 264 functions as a valve seat of a membrane valve for opening and closing the area between second channel 232 and second discharge channel 237. The shape and height of these partition walls are not limited as long as the above functions can be exhibited. These partition walls have, for example, a quadrangular prism shape. The height of each partition wall is, for example, the same as the depth of the corresponding channel.

Regarding diaphragm 256 of first introduction valve 243, diaphragm 258 of first discharge valve 244, diaphragm 276 of second introduction valve 263, and diaphragm 279 of second discharge valve 264, each diaphragm is part of flexible film 220 and has a substantially spherical crown shape (dome shape) (see FIG. 1A). Film 220 is disposed on substrate 210 in such a way that each diaphragm is not in contact with and faces each corresponding partition wall.

Regarding diaphragm 256 of first introduction valve 243, diaphragm 276 of first discharge valve 244, diaphragm 258 of second introduction valve 263, and diaphragm 279 of second discharge valve 264, each diaphragm bends toward each corresponding partition wall when the diaphragm is pressed by first protrusion 112 (described below) of first rotary member 110. These diaphragms thus function as valve bodies for diaphragm valves. For example, when first protrusion 112 is not pressing diaphragm 256 of first introduction valve 243, first introduction channel 234 and first channel 231 communicate with each other through the gap between diaphragm 256 and partition wall 255. On the other hand, when first protrusion 112 presses diaphragm 256 so that diaphragm 256 contacts partition wall 255, first introduction channel 234 and first channel 231 do not communicate with each other.

Rotary membrane pump 270 is a space which has a substantially arc shape (“C” shape) in plan view and is formed between substrate 210 and film 220. One end side of rotary membrane pump 270 is connected to vent hole 271, and the other end side of rotary membrane pump 270 is connected to third channel 233. In the present embodiment, rotary membrane pump 270 is formed of the bottom surface of substrate 210 and diaphragm 272 facing the bottom surface while being separated from the bottom surface. Diaphragm 272 is part of flexible film 220 (see FIG. 1A). Diaphragm 272 is disposed on the circumference of one circle with second central axis CA2 at the center. The cross-sectional shape—perpendicular to the circumference—of diaphragm 272 is not limited, and is arc-shaped in the present embodiment.

Diaphragm 272 of rotary membrane pump 270 bends and contacts substrate 210 when pressed by second protrusion 122 (described below) of second rotary member 120. For example, when second protrusion 122 slides along and presses diaphragm 272 from the connection part with third channel 233 toward the connection part with vent hole 271 (counterclockwise in FIG. 3), the pressure inside third channel 233 becomes negative, the fluid inside third channel 233 moves toward rotary membrane pump 270, and the liquid in first channel 231 or second channel 232 moves into the inside of third channel 233. On the other hand, when second protrusion 122 slides along and presses diaphragm 272 from the connection part with vent hole 271 toward the connection part with third channel 233 (clockwise in FIG. 3), pressure inside third channel 233 becomes positive, and the liquid inside third channel 233 moves into the inside of first channel 231 or the inside of second channel 232.

Vent hole 271 is a bottomed recess for introducing fluid (for example, air) into rotary membrane pump 270 or discharging fluid (for example, air) from the inside of rotary membrane pump 270 when second protrusion 122 of second rotary member 120 slides along and presses diaphragm 272 of rotary membrane pump 270. In the present embodiment, vent hole 271 is formed of a through hole formed in substrate 210 and film 220 blocking one of the openings of the through hole. The shape and size of vent hole 271 are not limited, and can be appropriately set as necessary. Vent hole 271 has, for example, a substantially cylindrical shape. The width of vent hole 271 is, for example, approximately 2 mm.

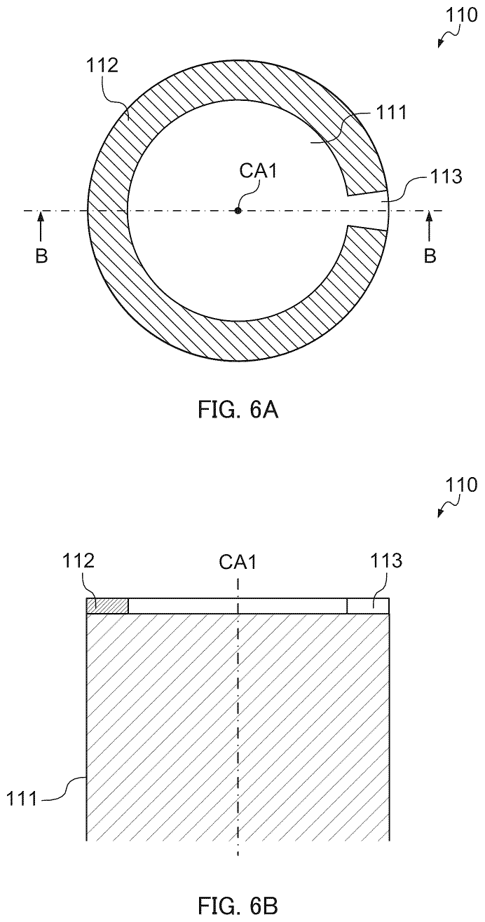

FIG. 6A is a plan view of first rotary member 110, and FIG. 6B is a cross-sectional view taken along line B-B of FIG. 6A. In FIG. 6A, hatching is provided on the top surface of first protrusion 112 for distinct showing of the surface.

First rotary member 110 includes first main body 111 having a cylindrical shape, first protrusion 112 disposed on the top surface of first main body 111, and first recess 113 disposed in the top surface of first main body 111. First main body 111 is rotatable about first central axis CA1. First main body 111 is rotated by an external drive mechanism (not illustrated).

First main body 111 includes, in the upper portion thereof, first protrusion 112 and first recess 113. First protrusion 112 is configured to close first introduction valve 243, first discharge valve 244, second introduction valve 263, and second discharge valve 264 by pressing diaphragm 256, diaphragm 258, diaphragm 276, and diaphragm 279. First recess 113 is configured to open these valves by not pressing these diaphragms. First protrusion 112 and first recess 113 are disposed on the circumference of a circle whose center is first central axis CA1. In the present embodiment, first protrusion 112 in plan view has a shape of an arc (“C” shape) corresponding to a portion of the circle whose center is first central axis CA1. The region, on the circumference, where first protrusion 112 is not present is first recess 113.

First protrusion 112 projects relatively with respect to first recess 113, and first recess 113 is recessed relatively with respect to first protrusion 112. In other words, first protrusion 112 functions as a pressing part, and first recess 113 functions as non-pressing part. In the example illustrated in FIG. 6B, for example, first protrusion 112 projects from the top surface (reference surface) of first main body 111, and the bottom surface of first recess 113 is at the same height as the top surface (reference surface) of first main body 111. Alternatively, the top surface of first protrusion 112 may be at the same height as the top surface (reference surface) of first main body 111, and in this case, first recess 113 is recessed into the top surface (reference surface) of first main body 111.

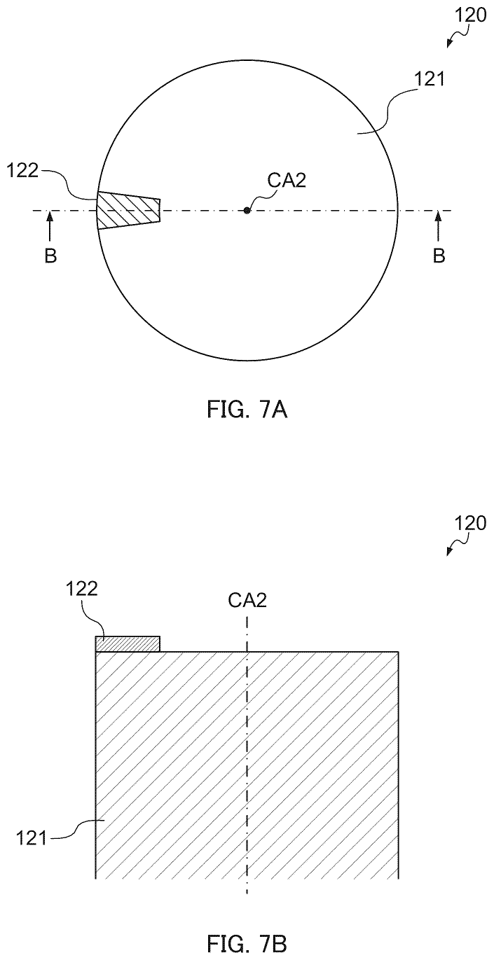

FIG. 7A is a plan view of second rotary member 120, and FIG. 7B is a cross-sectional view taken along line B-B of FIG. 7A. In FIG. 7A, hatching is provided on the top surface of second protrusion 122 for distinct showing of the surface.

Second rotary member 120 includes second main body 121 having a cylindrical shape and second protrusion 122 disposed on the top surface of second main body 121. Second main body 121 is rotatable about second central axis CA2. Second main body 121 is rotated by an external drive mechanism (not illustrated).

Second main body 121 includes, in the upper portion thereof, second protrusion 122 configured to operate rotary membrane pump 270 by pressing diaphragm 272 while sliding along the diaphragm. Second protrusion 122 is disposed on the circumference of a circle whose center is second central axis CA2. Second protrusion 122 may have any shape as long as rotary membrane pump 270 can be operated appropriately. In the present embodiment, second protrusion 122 in plan view has a shape of an arc corresponding to a portion of the circle whose center is second central axis CA2.

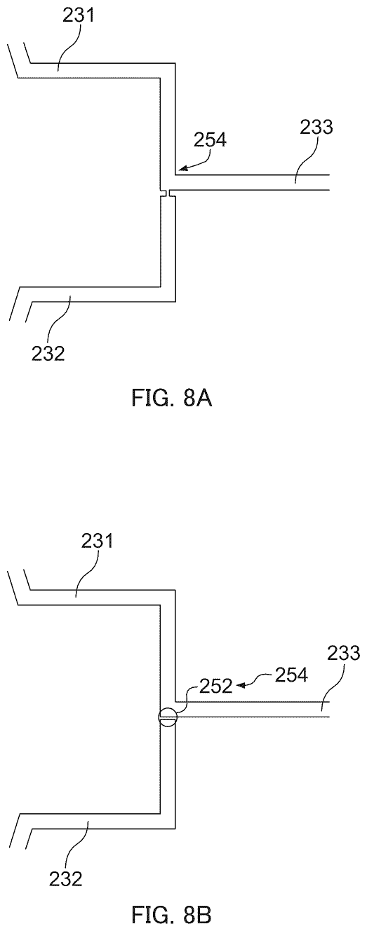

Pressure loss part 254 may be disposed in the connection portion between first channel 231 and third channel 233 or in the connection portion between second channel 232 and third channel 233. FIG. 8A is a diagram for explaining a pressure loss part, and FIG. 8B is a diagram for explaining another pressure loss part. Pressure loss part 254 functions when selectively allowing the liquid in third channel 233 to enter first channel 231 or second channel 232. Pressure loss part 254 is disposed in a channel into which a liquid introduced from first introduction port 241 should not enter. Pressure loss part 254 may have any structure as long as the pressure loss that occurs at pressure loss part 254 is greater than the pressure loss at the connection part to which the liquid introduction port for introducing a liquid is connected.

The difficulty of liquid flow in a channel depends on the highest resistance value in the channel. In the present embodiment, first channel 231, second channel 232, and third channel 233 all have the same cross-sectional area; thus, for changing the difficulty of the liquid flow, it is necessary to provide a region (resistance), in which the liquid is difficult to flow, in the channels. For example, the difficulty of the liquid flow in the channel between first introduction port 241 and third channel 233 and the difficulty of the liquid flow in second channel 232 depend on the pressure loss at first introduction connection part 265 and the pressure loss at the connection portion between second channel 232 and third channel 233. For discharging a liquid from second discharge port 262, when the liquid introduced from first introduction port 241 enters second channel 232, liquid is discharged excessively by the volume of the liquid that has entered second channel 232. The parts are formed in such a way that the pressure loss in first introduction connection part 265 is smaller than the pressure loss in pressure loss part 254 that is between second channel path 232 and third channel 233. Therefore, a liquid introduced from first introduction port 241 enters first channel 231 and then enters only third channel 233 without entering second channel 232.

Examples of the structure of pressure loss part 254 include a structure having a reduced cross-sectional area of in channel and a structure having a zigzagged channel. In the present embodiment, pressure loss part 254 has a reduced cross-sectional area in a channel. A method for reducing the cross-sectional area in a channel is not limited. Examples of the method for reducing the cross-sectional area in a channel may include the following: forming a narrow groove (to be formed in substrate 210) as illustrated in FIG. 8A; providing a partition wall at the connection portion that is between first channel 231 and third channel 233 or the connection portion that is between second channel 232 and third channel 233, thereby providing a valve structure similar to first introduction valve 243 as illustrated in FIG. 8B. In addition, examples of the method for forming a narrow groove (to be formed in substrate 210) include a method for reducing the width of the groove and a method for reducing the depth of the groove. In the present embodiment, the cross-sectional area of the channel is reduced by narrowing the width of the groove, thereby increasing the pressure loss.

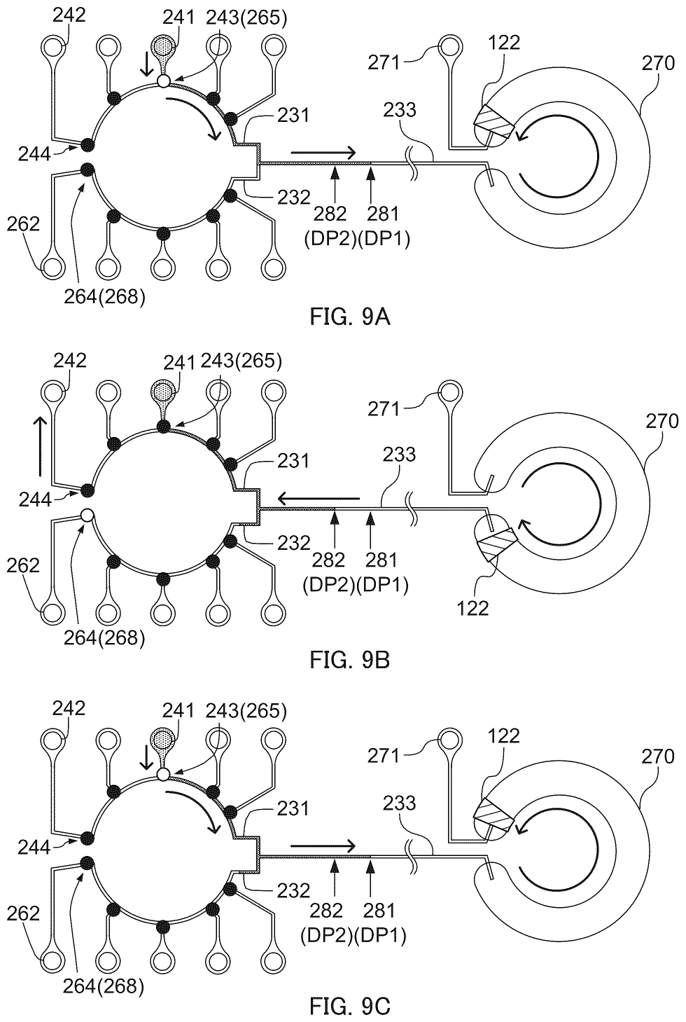

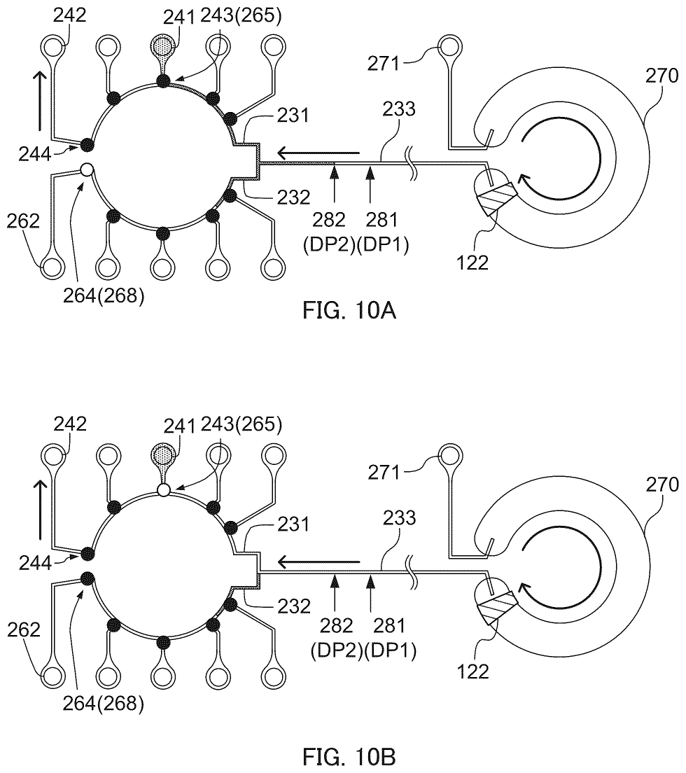

Operation of Liquid Handling System (Liquid Handling Method) In the following, the operation of liquid handling system 100 will be described with reference to FIGS. 9A to 9C and 10A to 10C. Regarding first introduction valves 243, first discharge valve 244, second introduction valves 263, and second discharge valve 264 in FIGS. 9A to 9C and 10A to 10C, when first protrusion 112 of first rotary member 110 presses and blocks a valve, the valve is indicated by a black circle, and when first recess 113 faces a valve and does not block the valve, the valve is indicated by an unfilled circle, for convenience of explanation. In addition, in FIGS. 9A and 9B, the amount of movement of second protrusion 122 in rotary membrane pump 270 is illustrated schematically, and the amount of movement of second protrusion 122 is not proportional to the amount of movement of the liquid.

The present embodiment describes the following case: a liquid whose volume is twice that of the space between first to-be-detected region 281 (first detection point DP1) and second to-be-detected region 282 (second detection point DP2) is weighed.

The liquid handling method according to the present embodiment performs the following procedure more than once: a liquid is introduced from introduction port 241 into third channel 233 until the surface of the liquid is positioned at first light detection part 140a, and then the liquid inside third channel 233—the liquid with the liquid surface thereof at first light detection part 140a—is moved toward one end of third channel 233 so that the liquid surface is positioned at second light detection part 140b.

First, a liquid (for example, a sample such as blood) is introduced into first introduction port 241. At this time, all valves are closed.

Next, first rotary member 110 is rotated to open only first introduction valve 243 in first channel 231, and second rotary member 120 is rotated to cause rotary membrane pump 270 to suck a fluid (for example, air) inside third channel 233. As a result, the liquid inside first introduction port 241 is introduced from first introduction channel 234 into third channel 233, as illustrated in FIG. 9A. At this time, the liquid is introduced into third channel 233 until the liquid reaches first detection point DP1 of first to-be-detected region 281. In the present embodiment, the head position of the liquid introduced inside third channel 233 is detected by irradiating first detection point DP1 set in third channel 233 with light from first light irradiation part 130a, and detecting light from first detection point DP1 by first light detection part 140a. When the liquid reaches first detection point DP1, the rotation of second rotary member 120 is stopped to stop the suction by rotary membrane pump 270.

Next, first rotary member 110 is rotated to open only second discharge valve 264, and second rotary member 120 is rotated. As a result, the fluid inside rotary membrane pump 270 is pushed into third channel 233 as illustrated in FIG. 9B. At this time, the fluid is pushed into third channel 233 until the liquid reaches second detection point DP2 of second to-be-detected region 282. In the present embodiment, the head position of the liquid inside third channel 233 is detected by irradiating second detection point DP2 set in third channel 233 with light from second light irradiation part 130b, and detecting light from second detection point DP2 by second light detection part 140b. When the liquid reaches second detection point DP2, the rotation of second rotary member 120 is stopped to stop the pushing by rotary membrane pump 270. Through the procedures up to this point, in second channel 232, a liquid whose volume is equal to the volume of the space between first to-be-detected region 281 (first detection point DP1) and second to-be-detected region 282 (second detection point DP2) is weighed.

First rotary member 110 is then rotated to open only first introduction valve 243 in first channel 231, and second rotary member 120 is rotated to cause rotary membrane pump 270 to suck the fluid inside third channel 233. As a result, the liquid inside first introduction port 241 is introduced from first introduction channel 234 into third channel 233, as illustrated in FIG. 9C. At this time, the liquid is introduced into third channel 233 until the liquid reaches first detection point DP1 of first to-be-detected region 281. The method of detecting liquid at first detection point DP1 of first to-be-detected region 281 is as described above. When the liquid reaches first detection point DP1, the rotation of second rotary member 120 is stopped to stop the suction by rotary membrane pump 270.

Next, first rotary member 110 is rotated to open only second discharge valve 264, and second rotary member 120 is rotated. As a result, the fluid inside rotary membrane pump 270 is pushed into third channel 233 as illustrated in FIG. 10A. At this time, the fluid is pushed into third channel 233 until the liquid reaches second detection point DP2 of second to-be-detected region 282. The method of detecting liquid at second detection point DP2 of second to-be-detected region 282 is as described above. When the liquid reaches second detection point DP2, the rotation of second rotary member 120 is stopped to stop the pushing by rotary membrane pump 270. Through the procedures up to this point, in second channel 232, a liquid whose volume is twice the volume of the space between first to-be-detected region 281 (first detection point DP1) and second to-be-detected region 282 (second detection point DP2) is weighed. Air bubbles are not mixed in this liquid having the double volume.

The weighed liquid is then discharged. The discharge part for discharging the liquid may be first discharge port 242 or second discharge port 262.

For discharging to first discharge port 242, first rotary member 110 is rotated to open only first introduction valve 243 in first channel path 231, and second rotary member 120 is rotated to push the fluid of rotary membrane pump 270 into third channel 233. As a result, the liquid in first channel 231 and third channel 233 returns to first introduction port 241. As illustrated in FIG. 10B, the weighed liquid thus remains in second channel 232. At this time, the weighed liquid is continuous and contains no air bubble. Next, first rotary member 110 is rotated to open only second discharge valve 264 in second channel 232, and second rotary member 120 is rotated to cause rotary membrane pump 270 to suck the fluid (for example, air) inside third channel 233. As a result, the weighed liquid inside second channel 232 is moved to third channel 233. Next, first rotary member 110 is rotated to open only first discharge valve 244 in first channel 231, and second rotary member 120 is rotated to push the fluid of rotary membrane pump 270 into third channel 233. As a result, the weighed liquid inside third channel 233 is moved to first discharge port 242.

For discharging to second discharge port 262, first rotary member 110 is rotated to open, for example, only first introduction valve 243 in first channel path 231, and second rotary member 120 is rotated to push the fluid of rotary membrane pump 270 into third channel 233. As a result, the liquid in first channel 231 and third channel 233 returns to first introduction port 241. As illustrated in FIG. 10B, the weighed liquid thus remains in second channel 232. Next, first rotary member 110 is rotated to open only second discharge part 264 in second channel 232, and second rotary member 120 is rotated to push the fluid of rotary membrane pump 270 into third channel 233. As a result, the weighed liquid in second channel 232 is discharged to second discharge port 262.

Effects

As described above, the present invention can appropriately weigh liquid at a desired amount because no air bubble is mixed in the weighed liquid. In addition, air bubbles do not mix in the weighed liquid; thus detection can be performed with high accuracy without being affected by air bubbles.

### INDUSTRIAL APPLICABILITY

Liquid handling systems of the present invention are particularly advantageous, for example, in a variety of applications such as clinical, food, and environmental testing.

### REFERENCE SIGNS LIST

100 Liquid handling system
110 First rotary member
111 First main body
112 First protrusion
113 First recess
120 Second rotary member
121 Second main body
122 Second protrusion
130 Light irradiation part
130a First light irradiation part
130b Second light irradiation part
140 Light detection part
140a First light detection part
140b Second light detection part
200 Liquid handling device
210 Substrate
220 Film
231 First channel
232 Second channel
233 Third channel
234 First introduction channel
235 First discharge channel
236 Second introduction channel
237 Second discharge channel
241 First introduction port
242 First discharge port
243 First introduction valve
244 First discharge valve
254 Pressure loss part
255, 257, 275, 278 Partition wall
252, 256, 258, 272, 276, 279 Diaphragm
261 Second introduction port
262 Second discharge port
263 Second introduction valve
264 Second discharge valve
265 First introduction connection part
266 First discharge connection part
267 Second introduction connection part
268 Second discharge connection part
270 Rotary membrane pump
271 Vent hole
281 First to-be-detected region
282 Second to-be-detected region
283 Roughened surface
284 Light shielding part
CA1 First central axis
CA2 Second central axis
DP1 First detection point
DP2 Second detection point

1. A liquid handling device, comprising:
a first channel;
a second channel;
a third channel with one end thereof connected to one end of the first channel and to one end of the second channel;
an introduction port connected to the first channel or the second channel;
a discharge port connected to the first channel or the second channel;
an introduction valve disposed in a first connection part between the introduction port and the first channel or the second channel, the first channel or the second channel being a channel to which the introduction port is connected; and
a discharge valve disposed in a second connection part between the discharge port and the first channel or the second channel, the first channel or the second channel being a channel to which the discharge port is connected,
wherein
the third channel includes
a first to-be-detected region including a roughened surface and being configured to be irradiated with light for detection of transmitted light or reflected light, the first to-be-detected region being disposed in the third channel, and
a second to-be-detected region including a roughened surface and being configured to be irradiated with light for detection of transmitted light or reflected light, the second to-be-detected region being disposed in the third channel and closer to the one end of the third channel than the first to-be-detected region is.

2. The liquid handling device according to claim 1, wherein both the introduction valve and the discharge valve are membrane valves and are disposed on one circle.

3. The liquid handling device according to claim 1, further comprising, a rotary membrane pump connected to the other end of the third channel.

4. A liquid handling system, comprising:
the liquid handling device according to claim 1;
a first light detection part disposed to face the first to-be-detected region; and
a second light detection part disposed to face the second to-be-detected region.

5. A liquid handling method for weighing a liquid by using the liquid handling system according to claim 4, the liquid handling method comprising:
performing a procedure more than once, wherein, in the procedure, a liquid is introduced from the introduction port into the third channel until a surface of the liquid is positioned at the first light detection part, and then the liquid inside the third channel and with the surface thereof at the first light detection part is moved toward the one end of the third channel so that the surface of the liquid is positioned at the second light detection part.

6. The liquid handling device according to claim 2, further comprising, a rotary membrane pump connected to the other end of the third channel.

7. A liquid handling system, comprising:
the liquid handling device according to claim 2;
a first light detection part disposed to face the first to-be-detected region; and
a second light detection part disposed to face the second to-be-detected region.

8. A liquid handling system, comprising:
the liquid handling device according to claim 3;
a first light detection part disposed to face the first to-be-detected region; and
a second light detection part disposed to face the second to-be-detected region.

9. A liquid handling system, comprising:
the liquid handling device according to claim 6;
a first light detection part disposed to face the first to-be-detected region; and
a second light detection part disposed to face the second to-be-detected region.

10. A liquid handling method for weighing a liquid by using the liquid handling system according to claim 7, the liquid handling method comprising:
performing a procedure more than once, wherein, in the procedure, a liquid is introduced from the introduction port into the third channel until a surface of the liquid is positioned at the first light detection part, and then the liquid inside the third channel and with the surface thereof at the first light detection part is moved toward the one end of the third channel so that the surface of the liquid is positioned at the second light detection part.

11. A liquid handling method for weighing a liquid by using the liquid handling system according to claim 8, the liquid handling method comprising:
performing a procedure more than once, wherein, in the procedure, a liquid is introduced from the introduction port into the third channel until a surface of the liquid is positioned at the first light detection part, and then the liquid inside the third channel and with the surface thereof at the first light detection part is moved toward the one end of the third channel so that the surface of the liquid is positioned at the second light detection part.

12. A liquid handling method for weighing a liquid by using the liquid handling system according to claim 9, the liquid handling method comprising:
performing a procedure more than once, wherein, in the procedure, a liquid is introduced from the introduction port into the third channel until a surface of the liquid is positioned at the first light detection part, and then the liquid inside the third channel and with the surface thereof at the first light detection part is moved toward the one end of the third channel so that the surface of the liquid is positioned at the second light detection part.
